(19) United States
(12) Patent Application Publication
(10) Pub. No.: US 2025/0165398 A1
(43) Pub. Date: May 22, 2025

(54) STORAGE DEVICE AND A METHOD OF CONTROLLING DATA STORING AREA

(71) Applicant: Hitachi, Ltd., Tokyo (JP)

(72) Inventors: Sadahiro SUGIMOTO, Tokyo (JP); Tomohiro Yoshihara, Tokyo (JP); Takashi Nagao, Tokyo (JP)

(73) Assignee: Hitachi, Ltd., Tokyo (JP)

(21) Appl. No.: 18/582,230

(22) Filed: Feb. 20, 2024

(30) Foreign Application Priority Data
Nov. 22, 2023 (JP) 2023-198384

(51) Int. Cl. G06F 12/0802

(52) U.S. Cl. CPC G06F 12/0802; G06F 2212/60

(57) ABSTRACT

A controller has a memory data protection function of generating a cache data log including data of a memory and a header related to update of the data and writing the cache data log to any one of a plurality of kinds of drives, and the controller uses the memory data protection function to select, from the plurality of kinds of drives, a drive that is to store the cache data log, according to necessary performance, and store the cache data log in the selected drive.

### BACKGROUND OF THE INVENTION

### 1. Field of the Invention

The present invention relates to a storage apparatus and a storage location control method, and the present invention is suitably applied to, for example, a storage apparatus related to a technique for writing data of a memory and update content of the data as a log to a drive in a process of inputting and outputting data to and from a host.

### 2. Description of the Related Art

A storage apparatus writes data received from a host computer (hereinafter, abbreviated as a “host”) to a non-volatile drive (hereinafter, abbreviated as a “drive”), such as a solid state drive (SSD) and a hard disk drive (HDD), through a cache memory (hereinafter, abbreviated as a “cache”). That is, the data requested to be written from the host is temporarily held in the cache and then written to a predetermined drive. There are roughly two kinds of methods for writing the data from the cache to the drive.

One of the methods is, for example, what is generally called a write-through method, and in the method, the data is written to the drive before a response to the write request is returned to the host. The other of the methods is, for example, what is generally called a write-back method or a write-after method, and in the method, a response to the write request is returned to the host when the data is stored in the cache. In the write-back method, the data is written to the drive at a freely-selected timing after the data is stored in the cache.

Therefore, in the write-back method, the response can be returned to the host without waiting for the completion of the writing to the drive, and the response time can be shorter than in the write-through method. On the other hand, the data completed with the writing from the host temporarily exists only on the cache in the write-back method. Therefore, the data on the cache needs to be appropriately protected. The storage apparatus includes, for example, a plurality of controllers with a redundant configuration, and the data received by one controller is copied to the cache of another controller to secure the redundancy of data. In addition, the cache is protected by, for example, a battery to prepare for a power failure or a malfunction of power supply.

Both high reliability and high performance are required for the storage apparatus. Therefore, the storage apparatus can properly use the write-through method and the write-back method according to the situation. In recent years, there is a known method of properly using the methods, in which the write-back method is used when the cache can appropriately be protected and the method is switched to the write-through method in a situation where the cache cannot be protected. In this way, the response can quickly be returned by the write-back method during the normal time, and the reliability can be secured by the write-through method even when, for example, the redundancy of the cache is lost due to a malfunction of the controller.

However, a relatively complicated data protection method, such as redundant array of independent disks (RAID) 6, is applied to the storage apparatus of recent years, and the response time is often long in the operation of the write-through method. For example, in the case of RAID 6, old data and two old parities (a P parity and a Q parity) need to be read from the drive to generate parity data every time a write request is received from the host, and the response needs to be returned to the host after new data and two new parities are written to the drive. In this way, the drive needs to be accessed for a plurality of times, and the response to the host becomes late.

On the other hand, in a method disclosed in U.S. Pat. No. 11,609,698, the update content of the data on the memory is written in a form of a log to the drive to thereby protect the data on the memory. In the method, the response can be returned to the host after the update content of the memory related to the write request from the host is written as a log to the drive.

Therefore, the number of times the drive is accessed is smaller than in the write-through method, and the response time can be reduced.

In the method disclosed in U.S. Pat. No. 11,609,698, the update content itself of the data on the memory is written as a log to the drive, and the amount of data written to the drive is larger than in the write-back method. Therefore, the drive that stores the log may become a bottleneck for the performance, and the high reliability may not be secured. Although, for example, a large number of high-speed SSDs can be used as drives that store logs, the cost for preparing the drives may become high if such a configuration is adopted. On the other hand, there are various requirements for the storage apparatus. The performance is considered to be important in some cases, and the cost needs to be suppressed in exchange for the performance in other cases. Therefore, the cost and the performance need to be appropriately balanced according to the requirements desired by a user.

The present invention has been made in view of the foregoing, and the present invention is intended to propose a storage apparatus that can secure high reliability while balancing the cost and the performance and to propose a log storage location control method that can secure high reliability while balancing the cost and the performance.

### SUMMARY OF THE INVENTION

To solve the problem, the present invention provides a storage apparatus including a plurality of kinds of drives that store data in a non-volatile manner, a plurality of controllers that control reading and writing of the data to and from a host, and a volatile memory that temporarily stores the data. Each of the plurality of controllers has a memory data protection function of generating a cache data log including the data of the memory and a header related to update content of the data and writing the cache data log to any one of the plurality of kinds of drives, and the controller uses the memory data protection function to select, from the plurality of kinds of drives, a drive that is to store the cache data log, according to necessary performance, and store the cache data log in the selected drive.

The present invention provides a storage location control method of a storage apparatus including a plurality of kinds of drives that store data in a non-volatile manner, a plurality of controllers that control reading and writing of the data to and from a host, and a volatile memory that temporarily stores the data. The storage location control method includes a data protection step of executing, by each of the plurality of controllers, a memory data protection function of generating a cache data log including the data of the memory and a header related to update content of the data and writing the cache data log to any one of the plurality of kinds of drives. In the data protection step, the controller uses the memory data protection function to select, from the plurality of kinds of drives, a drive that is to store the cache data log, according to necessary performance, and store the cache data log in the selected drive.

According to the present invention, the high reliability can be secured while the cost and the performance are balanced.

### BRIEF DESCRIPTION OF THE DRAWINGS

FIG. 1 is a block diagram illustrating an example of a configuration example of a storage apparatus according to the present embodiment;

FIG. 2 depicts an example of an overview of a writing operation performed when both controllers are normal;

FIG. 3 depicts an example of an overview of a writing operation performed when one of the controllers of the storage apparatus is blocked;

FIG. 4 depicts an example of storage content of a memory;

FIG. 5 depicts an example of content of a control information log storage location management table;

FIG. 6 depicts an example of content of a cache data log storage location management table;

FIG. 7 is a flow chart illustrating an example of a procedure of a control information log storage location setting process;

FIG. 8 is a flow chart illustrating an example of a procedure of a cache data log storage location setting process;

FIG. 9 is a flow chart illustrating an example of a procedure of a writing process;

FIG. 10 is a flow chart illustrating an example of a procedure of a destaging process;

FIG. 11 is a flow chart illustrating an example of a procedure of a control information updating process;

FIG. 12 is a flow chart illustrating an example of a procedure of a cache data updating process;

FIG. 13 is a flow chart illustrating an example of a procedure of a log creating process;

FIG. 14 is a flow chart illustrating an example of a procedure of a log saving process;

FIG. 15 is a flow chart illustrating an example of a procedure of a base image saving process;

FIG. 16 is a flow chart illustrating an example of a procedure of a log recovery process;

FIG. 17 is a flow chart illustrating an example of a procedure of a memory protection method switching process performed when one of the controllers is blocked; and

FIG. 18 is a flow chart illustrating an example of a procedure of the memory protection method switching process performed when the controller is recovered.

### DESCRIPTION OF THE PREFERRED EMBODIMENT

An embodiment of the present invention will now be described in detail with reference to the drawings.

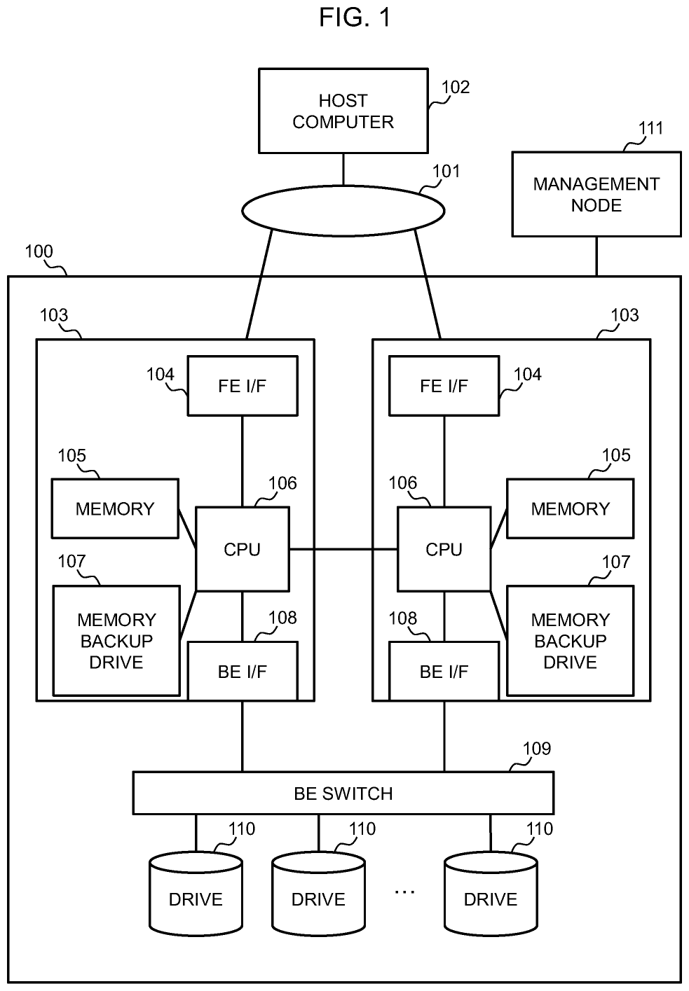

FIG. 1 is a block diagram illustrating an example of a configuration of a storage apparatus 100 according to the present embodiment. The storage apparatus 100 includes a plurality of controllers 103 and a drive 110 for user data (hereinafter, also referred to as a “UDD”). The controller 103 has a function of providing a host computer (hereinafter, referred to as a “host”) 102 with a volume including data to be read and written.

Each of the plurality of controllers 103 includes a central processing unit (CPU) 106, a memory 105, at least one memory backup drive 107, a front-end interface (hereinafter, abbreviated as an “FE I/F”) 104, and a back-end interface (hereinafter, abbreviated as a “BE I/F”) 108.

The drive 110 is a drive that stores data in a non-volatile manner. The drive 110 is, for example, an SSD including a non-volatile device, such as a flash memory, as a storage medium or is an HDD including a magnetic disk as a storage medium. A base image area for storing a base image described later is allocated to part of a storage area of the drive 110.

The memory 105 temporarily stores data, and the memory 105 is a semiconductor memory such as a dynamic random access memory (DRAM). A cache area that can temporarily store data is allocated to part of a storage area of the memory 105. In the present embodiment, the cache area will also be simply referred to as a “cache” in some cases.

The memory backup drive 107 is a drive that stores data in a non-volatile manner, and the memory backup drive 107 is a drive for memory backup. The memory backup drive 107 may be, for example, a drive of a non-volatile device, such as an SSD. The memory backup drive 107 is used to save storage content of the memory 105 when, for example, external power is lost.

The FE I/F 104 is, for example, a Fibre Channel host bus adapter (HBA) or a network interface controller (NIC). The BE I/F 108 is, for example, a serial attached small computer system interface (SCSI) (SAS), HBA, or Peripheral Component Interconnect-Express (PCI-Express) (hereinafter, abbreviated as “PCIe”) adapter or an NIC.

Each controller 103 and the drive 110 are connected to each other by, for example, a backend switch (hereinafter, abbreviated as a “BE switch”) 109. Further, the CPUs 106 of the plurality of controllers 103 are connected to each other by, for example, an interconnect, such as PCIe. Note that the CPUs 106 of the two controllers 103 may be connected to each other through, for example, a PCIe switch.

The storage apparatus 100 is connected to a storage area network (hereinafter, abbreviated as an “SAN”) 101, such as Fibre Channel and Ethernet. Further, the host 102 is also connected to the SAN 101. The SAN 101 may include a switch or the like. Moreover, a plurality of hosts may be connected to the SAN 101.

A management node 111 is connected to the storage apparatus 100. The management node 111 is a computer for an administrator to operate a program for configuring settings or the like of the storage apparatus 100. The management node 111 is connected to each controller 103 through, for example, a local area network (LAN) for management. Note that the management node 111 may be connected to the SAN 101 instead. Note that the management node 111 may not necessarily be an independent computer, and, for example, the function of the management node 111 may be included in the storage apparatus 100 or the host 102.

The storage apparatus 100 includes, in addition to the drive 110, the memory backup drive 107 that stores data in a non-volatile manner, and it can be stated that the storage apparatus 100 includes a plurality of kinds of drives that store data in a non-volatile manner. The plurality of controllers 103 control reading and writing of data to and from the storage apparatus 100 and the host 102.

Each of the controllers 103 in a data protection step has a memory data protection function of generating a cache data log including the data of the memory 105 and a header related to update of the data and writing the cache data log to any one of the plurality of kinds of drives. The controller 103 in the data protection step uses the memory data protection function to select, from the plurality of kinds of drives, a drive that is to store the cache data log, according to necessary performance.

In the present embodiment, when one of the plurality of controllers 103 is blocked, the other controller not blocked executes the memory data protection function in the data protection step.

In the present embodiment, it can be stated that the plurality of kinds of drives include the memory backup drive 107 as a storage area for saving the storage content of the memory 105 of the one controller 103 when the one controller 103 is blocked, and the drive 110 for user data (hereinafter, also referred to as the “UDD”) that reads and writes data regardless of whether or not the one controller 103 is blocked.

In the present embodiment, the data input and output to and from the host 102 includes a plurality of pieces of block-based data in which the data is divided into blocks. The cache data log includes the block-based data and the header related to the update of the block-based data. The other controller 103 in the data protection step selects, from the plurality of kinds of drives, the drive that is to store the block-based data and the header as the cache data log.

Note that, in the following description, the block-based data 201 and the data included in the block-based data 201 may simply be referred to as “data” when they do not have to be particularly distinguished from each other.

In the present embodiment, the other controller 103 that is not blocked selects the drive 110 from the plurality of kinds of drives when, for example, the necessary performance is set to prioritize that a predetermined performance requirement related to reading and writing speed of data is satisfied (hereinafter, referred to as “performance prioritized”). On the other hand, the other controller 103 selects the memory backup drive from the plurality of kinds of drives when the necessary performance is set to not prioritize that the predetermined performance requirement is satisfied (hereinafter, referred to as “performance not prioritized”). Note that, in the present embodiment, an example of the predetermined performance requirement includes that the drive does not become a bottleneck of the performance even when a cache data log described later with the amount of data larger than that of a control information log described later is written to the drive.

The plurality of kinds of drives in the present embodiment include at least one SSD, and in the data protection step, the other controller 103 that is not blocked selects the SSD from the plurality of kinds of drives when the necessary performance is set to prioritize that the predetermined performance requirement is satisfied.

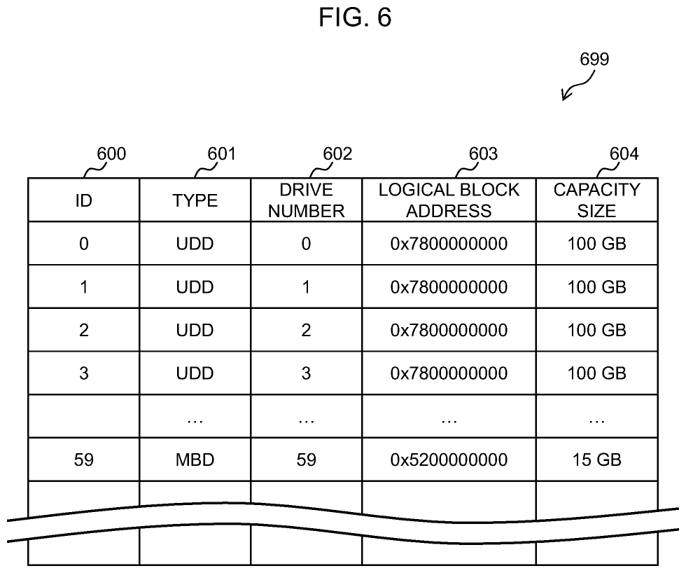

The storage apparatus 100 according to the present embodiment includes, in the memory 105, for example, a cache data log storage location management table (see FIG. 6) described in detail later that is an example of a storage location management table for managing information related to at least the type and the capacity related to the plurality of kinds of drives. The other controller 103 refers to the cache data log storage location management table to select the drive that is to store the cache data log. The memory 105 further includes a cache data log header table for managing the header of the cache data log.

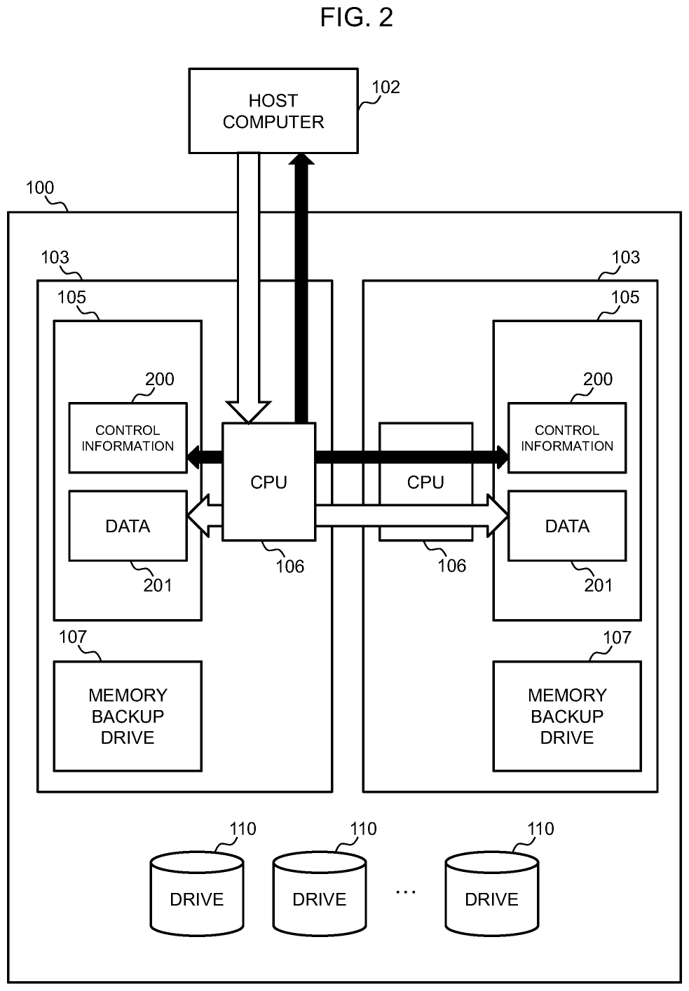

FIG. 2 depicts an example of an overview of a writing operation performed when both the controllers 103 are normal. In response to a write request from the host 102, the CPU 106 of the controller 103 receives block-based data 201 from the host 102 and writes the block-based data 201 to the memory 105 in the controller 103 and the memory 105 in the other controller 103. The CPU 106 updates control information 200 in the memory 105. The CPU 106 returns a writing completion response to the host 102.

In the writing operation, the block-based data 201 and the control information 200 on the memory 105 are duplicated between the plurality of controllers 103 to prepare for a malfunction of the controller 103.

As described above, the memory backup drive 107 is used as the saving location of the block-based data 201 and the control information 200 written to the memory 105, during a power failure. More specifically, when the power supply from the outside is shut down due to a power failure or the like, the controller 103 saves the block-based data 201 and the control information 200 of the memory 105 to the memory backup drive 107 before the battery as a backup of the memory 105 runs out. Once the saving is completed, the storage apparatus 100 is stopped.

After the power supply is recovered, the controller 103 can load, to the memory 105, the block-based data 201 and the control information 200 saved to the memory backup drive 107 and activate the storage apparatus 100 to thereby restart the operation of the storage apparatus 100 without losing the data before the shutdown.

Incidentally, the block-based data 201 of the memory 105 is written to the drive 110 at a freely-selected timing after the writing completion response (destage). In the destage, parity data or the like is generated to increase the reliability, and the parity data is written to a drive different from the drive for the block-based data 201.

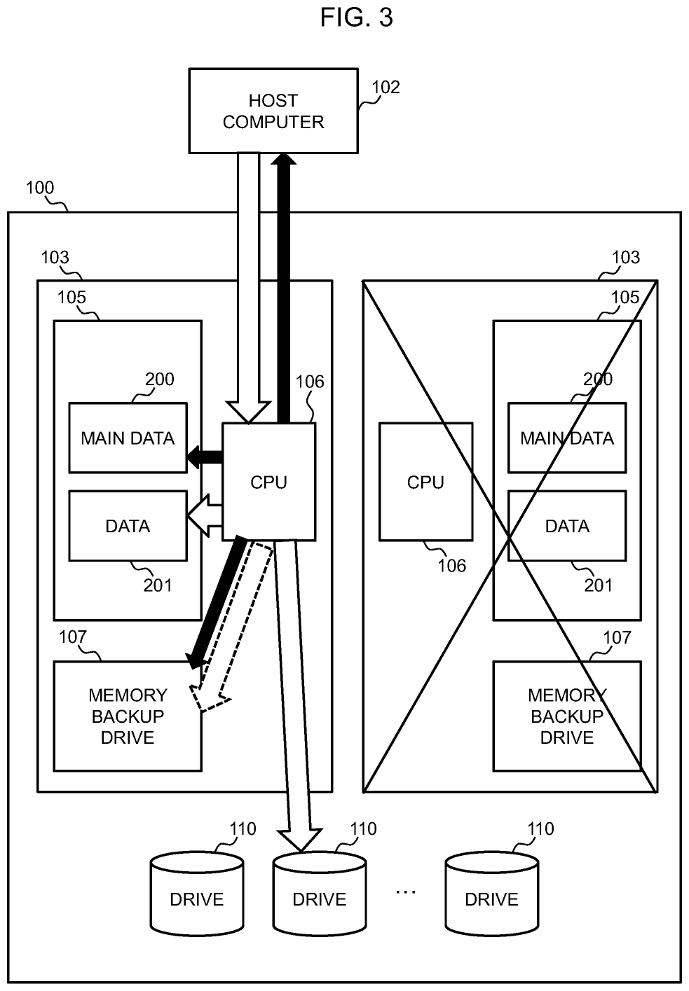

FIG. 3 depicts an example of an overview of a writing operation performed when one of the controllers 103 of the storage apparatus 100 is blocked.

In response to a write request from the host 102, the CPU 106 of the controller 103 receives the block-based data 201 from the host 102 and writes the block-based data 201 to the memory 105 in the controller 103. The CPU 106 also updates the control information 200 in the memory 105.

The CPU 106 further writes, as a cache data log, the block-based data 201 written from the host 102 and the header related to the update content of the block-based data 201 to the selected memory backup drive 107 or drive 110. The CPU 106 also writes, as a control information log, the control information 200 and the header of the update content of the control information 200 to the memory backup drive 107 or the drive 110. The CPU 106 then returns a writing completion response to the host 102.

Note that, in the present embodiment, the “header” represents, for example, information as update content of data including the address of the storage location of the data and the order of updating the data. The “log” includes, for example, a cache data log or a control information log. The “cache data log” represents the cache data (block-based data 201) and the header indicating the update content of the cache data. The “control information log” represents the control information (control information 200) and the header indicating the update content of the control information. Note that, as described above, the block-based data 201 written to the memory 105 is destaged at a freely-selected timing after the writing completion response.

In the writing operation, the block-based data 201 on the memory 105 and the update content of the block-based data 201 are written as the cache data log to the drive 110 (log saving) to thereby prepare for a malfunction of the remaining controller 103. In the log saving, the control information 200 and the update content of the control information 200 may also be written as a log to the drive 110 in addition to the cache data log. Although the storage apparatus 100 is temporarily stopped (system crash) if the remaining controller 103 malfunctions, the cache data log and the control information log can be used after the maintenance and replacement of the controller 103 to restore the block-based data 201 and the control information 200 on the memory 105 and thereby prevent a loss of data.

The difference between the “destage” and the “log saving” will be clarified here to prevent confusion in the following description. First, the “destage” represents writing of dirty data on the cache to the drive 110 that is a final storage medium. The drive 110 in general is often protected by a method such as RAID 6. In this case, parity data is generated in the destage, and the parity data is also written to the drive 110.

The block-based data 201 completed with the destage enters a state (hereinafter, referred to as “clean”) in which the block-based data 201 on the cache area of the memory 105 coincides with the block-based data 201 on the drive 110. Therefore, a loss of the block-based data 201 from the cache area is permissible.

On the other hand, the “log saving” is temporary writing of the cache data log representing the block-based data 201 (cache data) on the cache area of the memory 105 and the update content of the block-based data 201 or temporary writing of the control information log representing the control information 200 and the update content of the control information 200, to a non-volatile storage medium (drive), such as the memory backup drive 107, in preparation for a malfunction of the controller 103. The “log saving” is included in the memory data protection function.

Here, a state in which the block-based data 201 on the cache area does not coincide with the block-based data 201 on the drive 110 will be referred to as “dirty” in the present embodiment. Even when the log saving is completed, the dirty data on the cache area is held until the destage is completed. Once the destage is completed, the header of the block-based data 201 on the cache area also becomes unnecessary. Therefore, the log can be deleted from the drive when the destage is completed.

Note that, in the case of storing the cache data log in the memory backup drive 107 in the present embodiment, the area allocated to save the storage content of the memory 105 when both the controllers 103 are normal may be used as an area for storing the cache data log when one of the controllers 103 is blocked. In this way, a drive does not have to be added to store the cache data log, and the storage capacity does not have to be added. This is advantageous in terms of cost compared to when the cache data log is stored in the drive 110 or when a drive is additionally installed to store the cache data log.

Incidentally, the cache data log including the block-based data 201 and the update content of the block-based data 201 has relatively large granularity because the block-based data 201 written from the host 102 is in general on the basis of, for example, 512 byte or 4 Kbyte blocks. On the other hand, the control information 200 is, for example, on the basis of bytes, and the control information log including the update content of the control information 200 has relatively small granularity. In addition, the proportion of the cache area to the entire memory 105 is relatively large. Therefore, for the control information log, the entire memory area (hereinafter, referred to as a “base image”) storing the control information 200 is periodically written to the drive 110. All of the control information logs written before are destroyed, and the areas where the control information logs were written are collected as free spaces. This method will be referred to as a “base image saving method.”

On the other hand, for the cache data logs, unnecessary cache data logs that are not the newest of the cache data logs are identified, and the unnecessary cache data logs are destroyed (invalidated). In this way, free spaces with intervals are formed in the storage area (cache log buffer described later) of the cache data logs. Therefore, only valid cache data logs can be copied and shifted forward to another area at a predetermined timing to thereby collect consecutive free spaces. This method will be referred to as a “garbage collection method.”

In the present embodiment, both methods can properly be used to suppress the consumption of the storage capacity for saving the base image and reduce the management information for managing the free spaces. The overhead for collecting the free spaces can also be reduced.

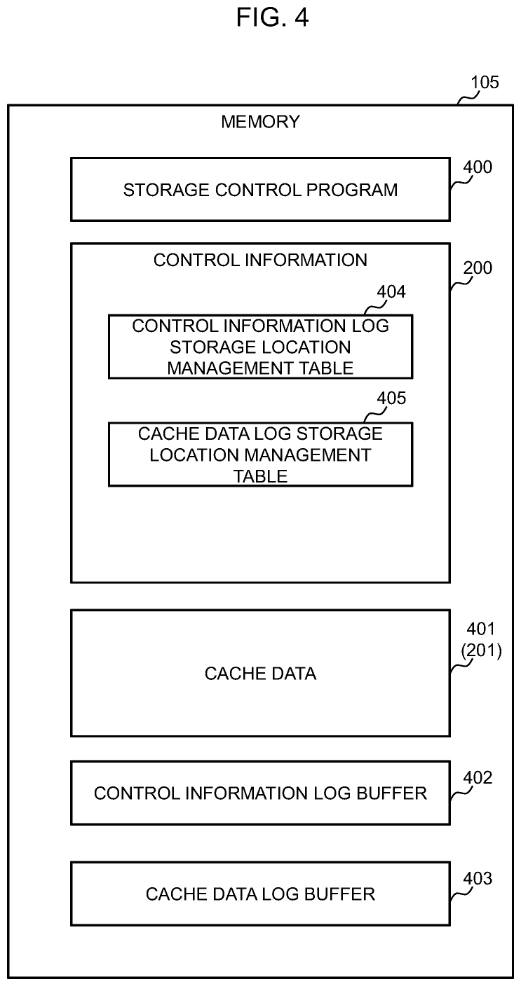

FIG. 4 depicts an example of the storage content of the memory 105. The memory 105 includes a storage control program 400, the control information 200, cache data 401, a control information log buffer 402, and a cache data log buffer 403. Note that, in the following description, the control information log buffer 402 and the cache data log buffer 403 will also be collectively referred to as a “log buffer.”

The storage control program 400 is a program for controlling the entire storage apparatus 100 under the control of the CPU 106. Processes, such as a writing process described later, are executed by the storage control program 400.

The control information 200 is data used by the storage control program 400 to control the execution of various programs. The control information 200 includes a control information log storage location management table 404 and a cache data log storage location management table 405. The content of the control information log storage location management table 404 and the cache data log storage location management table 405 will be described later.

The control information 200 includes cache control information, configuration information, information related to the state (such as normal/blocked) of the controllers 103, and the like. The cache control information includes, for example, information related to the correspondence between the address of the storage location of the cache data and the logical address in the volume (hereinafter, also abbreviated as an “LBA”), the state (dirty/clean) of the cache data, and the like. The configuration information includes, for example, information related to the type and the capacity of the drive, the type and the configuration of the RAID group, and the like.

Incidentally, in updating the control information 200 and the block-based data 201 of the memory 105 in the present embodiment, the headers regarding the update content may not be individually written one by one, and, for example, the headers may collectively be written to consecutive storage areas. However, for example, before the writing completion response is returned to the host 102, the block-based data 201 and the control information 200 updated by the writing may be written. This can prevent a loss of the written block-based data 201 due to a malfunction of the controller 103.

The control information log buffer 402 and the cache data log buffer 403 are storage areas of part of the memory 105 and are buffers for temporarily accumulating the cache data logs on the memory 105. The control information logs and the cache data logs are temporarily stored in the control information log buffer 402 and the cache data log buffer 403, respectively.

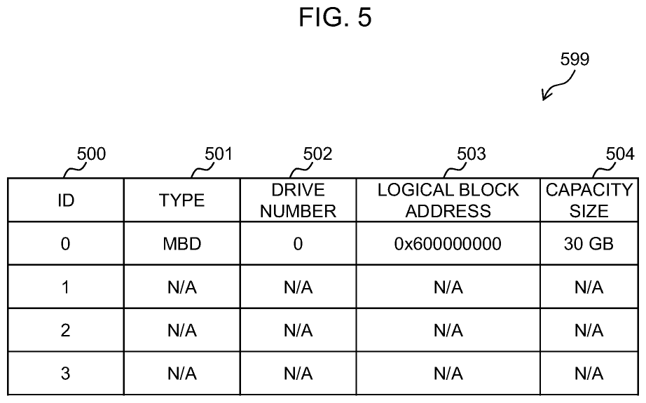

FIG. 5 depicts an example of content of a control information log storage location management table 599. For each area of the control information log storage location, a record is stored in each row in the control information log storage location management table 599. Each row includes columns of an identifier (ID) 500, a drive number 502, a logical block address (LBA) 503, and a capacity size 504.

When there is only one storage location for the control information logs in the control information log storage location management table 599, a value (illustrated “N/A”) representing an example of invalidity is stored in the remaining rows.

The ID 500 is, for example, a serial number starting from 0. The type 501 represents the types of the plurality of kinds of non-volatile drives, and, for example, values representing examples of the memory backup drive (hereinafter, also abbreviated as an “MBD”) 107 and the drive (hereinafter, also referred to as the “UDD”) 110 for user data are stored.

The drive number 502 is a number of the drive of the control information log storage location. The logical block address 503 is a start logical block address (LBA) of the area of the control information log storage location. The capacity size 504 represents an example of the size of the area of the control information log storage location. Although a value of the capacity size on the basis of GB is used for the simplification of the description of the capacity size 504 in the illustrated example, a value representing the number of blocks of the block-based data 201 is stored, for example.

FIG. 6 depicts an example of content of a cache data log storage location management table 699. The cache data log storage location management table 699 is a table with a column structure similar to that of the control information log storage location management table 599, and the meaning of each column is also similar to that of the control information log storage location management table 599.

In the case illustrated in FIGS. 5 and 6, the storage location of the control information log is allocated to the memory backup drive (MBD) 107, and the storage location of the cache data log is mainly allocated to the drive (UDD) 110. Although the actual allocation of the log storage location does not necessarily have to follow this example, a suitable policy of the allocation of the log storage location can be provided in terms of characteristics of each log, cost, and performance. The policy will be illustrated below.

First, the amount of data of the control information log is smaller than that of the cache data log, and the load of input and output to and from the drive storing the control information log is relatively smaller than that of the cache data log. On the other hand, the amount of data of the cache data log is larger than that of the control information log, and the load of input and output is large. The drive 110 may become a performance bottleneck.

Next, the memory backup drive 107 has an area allocated to save the storage content of the memory 105 in preparation for a power failure as described above. The capacity of the area is approximately the same as or greater than the capacity of the memory 105. When one of the controllers 103 is blocked, the other controller 103 uses the area as the log storage area. This can suppress the consumption of the capacity of the drive 110 and suppress the cost. On the other hand, a plurality of drives 110 are installed on the storage apparatus 100, and a large number of high-speed SSDs are often installed particularly in a case that requires high performance.

Therefore, it is desirable to allocate the storage location of the control information log to the memory backup drive 107. Further, it is desirable to allocate the storage location of the cache data log to the drive 110 when the satisfaction of the predetermined performance requirement is prioritized in the setting (hereinafter, referred to as “performance prioritized”). On the other hand, it is desirable to allocate the storage location of the cache data log to the memory backup drive 107 when the satisfaction of the predetermined performance requirement is not prioritized (when, for example, the cost is prioritized) in the setting (hereinafter, referred to as “performance not prioritized”). Alternatively, part of the storage location of the cache data log may be allocated to the drive 110, and the rest may be allocated to the memory backup drive 107, to satisfy the predetermined performance requirement. A flow chart illustrating an example of a specific procedure of a log storage location setting process will be described based on the policy described above.

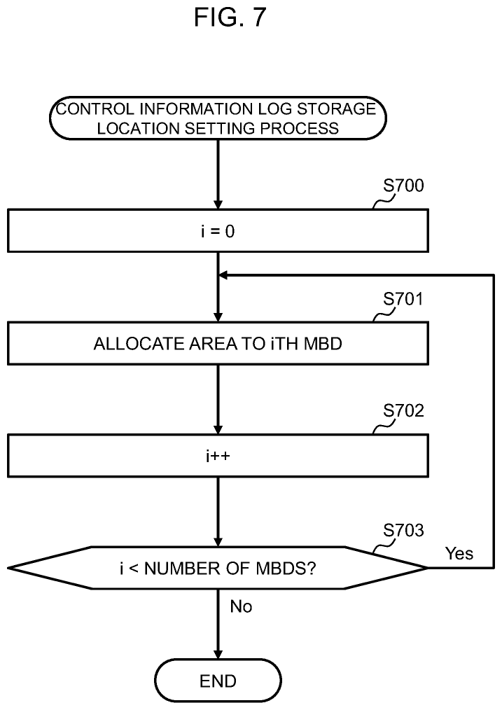

FIG. 7 is a flow chart illustrating an example of a procedure of a control information log storage location setting process. The control information log storage location setting process is executed by the storage control program 400 under the control of the CPU 106. Note that, in the description of the illustrated example, it is assumed that there are i memory backup drives (MBDs) 107. Further, although the subject of the following process is the storage control program 400 that operates under the control of the CPU 106, it is assumed in the following description that the CPU 106 executes the following process.

The CPU 106 first sets a counter i to “0” (step S700). The CPU 106 allocates the area for storing the control information log to an ith memory backup drive 107 (step S701). The CPU 106 then increments i (step S702), and if i is smaller than the number of memory backup drives 107, the CPU 106 returns to step S701 and repeatedly executes this.

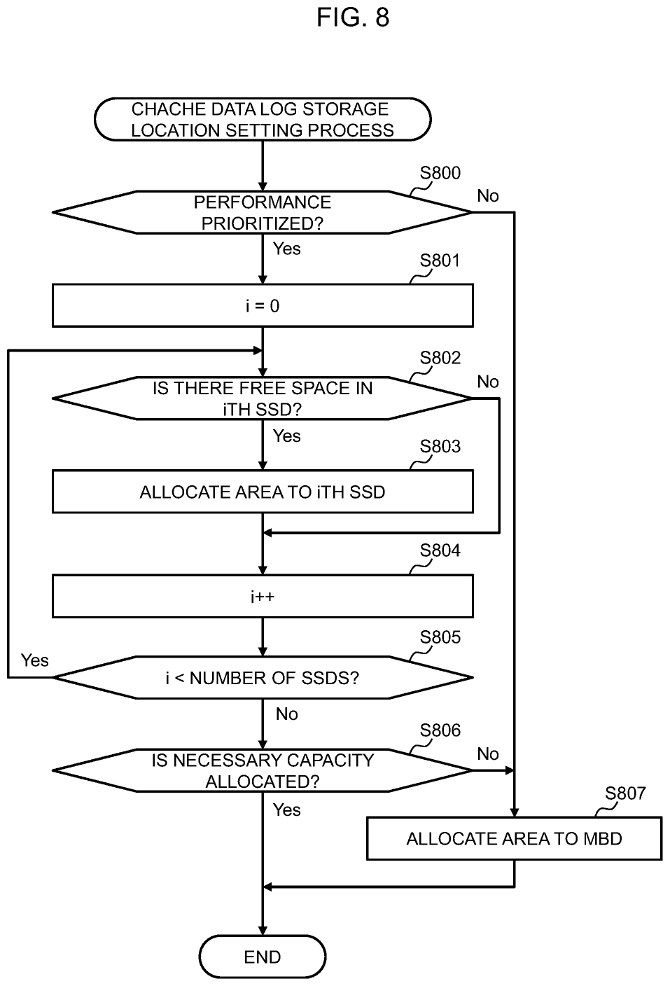

FIG. 8 is a flow chart illustrating an example of a procedure of a cache data log storage location setting process. The CPU 106 first determines whether or not the setting of the storage apparatus 100 is “performance prioritized.”

The administrator of the storage apparatus 100 may configure the “performance prioritized” setting, or the storage control program 400 of the storage apparatus 100 or the program of the management node 111 may automatically configure the “performance prioritized” setting, for example. To configure the automatic setting in the present embodiment, the determination is made as follows based on, for example, the apparatus configuration of the storage apparatus 100.

First, the CPU 106 installed on the controller 103 sets “performance not prioritized (cost prioritized)” if the CPU 106 determines that the performance of the CPU 106 is low and the memory backup drive 107 can follow the operation of the CPU 106 and predicts that the memory backup drive 107 does not become a bottleneck even if all the cache data logs are stored in the memory backup drive 107.

On the other hand, the CPU 106 installed on the controller 103 sets “performance prioritized” if the CPU 106 determines that the performance of the CPU 106 is high and the memory backup drive 107 cannot follow the operation of the CPU 106 and determines that there is a free space in a high-speed drive, such as an SSD, installed as the drive 110.

Note that, in another example of the method of automatic setting, the CPU 106 may set “performance prioritized” if the target performance designated in provisioning of the storage apparatus 100 is higher than a predetermined threshold and may set “performance not prioritized” if the target performance is equal to or smaller than the predetermined threshold, for example.

If “performance prioritized” is not set (that is, “cost prioritized” is set), the CPU 106 executes step S807. In step S807, the CPU 106 allocates the area for storing the cache data to the memory backup drive 107 (MBD). The procedure is similar to the control information log storage location setting process, and the description will not be repeated.

On the other hand, if “performance prioritized” is set, the CPU 106 sets the counter i to 0 (step S801). The CPU 106 determines whether or not there is a free space in the ith drive 110 (the drive is assumed to be, for example, an SSD here) that can store the cache data log (step S802).

If there is a free space, the CPU 106 allocates the area for storing the cache data log to the ith SSD (step S803). On the other hand, if there is no free space, the CPU 106 skips step S803 and executes step S804.

The CPU 106 then increments i (step S804), and if i is smaller than the number of SSDs, the CPU 106 returns to step S802 and repeats the process (step S805). The CPU 106 executes step S806 when i becomes equal to or greater than the number of SSDs.

In step S806, the CPU 106 determines whether or not the capacity necessary for storing the cache data is allocated. If the necessary capacity is allocated, the CPU 106 ends the process. On the other hand, if the allocation of the necessary capacity is not finished yet, the CPU 106 executes step S807.

Note that, in the flow chart, the area is allocated to the SSD among the drives 110 for user data, and the reason that the area is not allocated to, for example, an HDD is that the performance of the HDD is low. In the present embodiment, the area may not be allocated to a low-speed SSD, and the area may be allocated to a high-speed drive other than the SSD if such a drive is manufactured in the future.

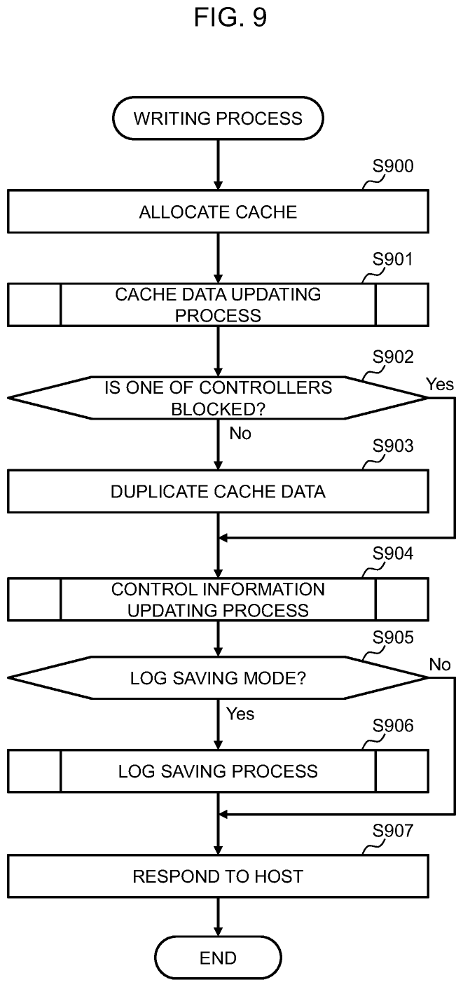

FIG. 9 is a flow chart illustrating an example of a procedure of a writing process. The CPU 106 first allocates a cache (step S900). The cache allocation denotes, for example, allocation of the area of the memory 105 that stores the cache data for an I/O process or the like. Here, an area with a size enough to store the block-based data 201 transmitted from the host 102 is allocated in order to store the block-based data 201.

The CPU 106 then executes a cache data updating process (step S901). The details of the cache data updating process will be described later. Simply put, the CPU 106 in the process receives the block-based data 201 from the host 102 and stores the block-based data 201 in the cache area allocated in the previous step.

The CPU 106 determines whether or not one of the controllers 103 is blocked (step S902). If one of the controllers 103 is blocked, the CPU 106 skips a cache data duplication process. On the other hand, if one of the controllers 103 is not blocked, that is, if both the controllers 103 are operating, the CPU 106 duplicates the cache data (step S903). The duplication of the cache data is a process of copying the block-based data 201 received from the host 102, to the memory 105 of the other controller 103. Here, a direct memory access (DMA) built in the CPU 106 is used to copy the data from the memory 105 of the controller 103 to the memory 105 of the other controller 103, for example.

The CPU 106 then executes a control information updating process (step S904). The details of the control information updating process will be described later.

The CPU 106 then determines whether or not the mode is a log saving mode (step S905). If the mode is the log saving mode (Yes), the CPU 106 executes a log saving process. On the other hand, if the mode is not the log saving mode (No), the CPU 106 skips the log saving process (step S906). The details of the log saving process will be described later. The CPU 106 finished with the process notifies the host 102 of the completion of the writing process (step S907). This completes the writing process.

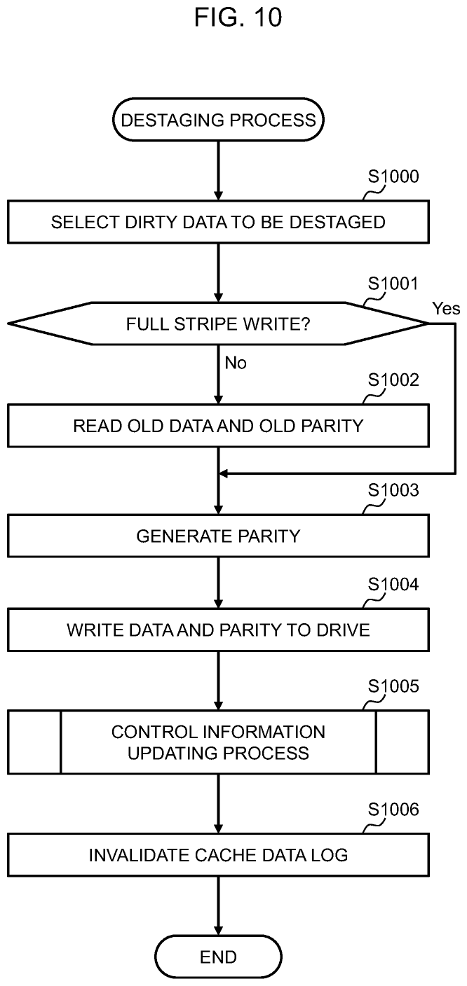

FIG. 10 is a flow chart illustrating an example of a procedure of a destaging process. The destaging process is started at a predetermined timing when there is dirty data on the memory 105. The frequency of starting the destaging process is adjusted based on the amount of dirty data and the state of the storage apparatus 100. For example, the larger the amount of dirty data, the higher the frequency of starting the destaging process. Further, the destaging process is started at a particularly high frequency when one of the controllers 103 is blocked and there is dirty data that is not stored in the drive 110 and that is not the target of the cache data log protection.

In the destaging process, the CPU 106 first selects data to be destaged (step S1000). The CPU 106 then determines whether or not full stripe write can be executed (step S1001). Here, the full stripe write can be executed when, for example, all pieces of data of three stripe blocks included in one stripe are present on the cache in the configuration of 3D+1P (three data blocks and one parity data block) in RAID 5.

In this way, whether or not all pieces of the data of one stripe in the data protection method, such as RAID 5 and RAID 6, are present on the cache is determined in step S1001. When the pieces of data of one stripe are present on the cache, the CPU 106 can generate new parity data without reading old data or old parity data from the drive 110. Therefore, if the full stripe write cannot be executed, the CPU 106 reads, from the drive 110, old data or old parity data necessary for updating the parity data (step S1002). If the full stripe write can be executed, the CPU 106 skips step S1002.

The CPU 106 then generates new parity data (step S1003) and writes the data and the new parity data to the drive 110 (step S1004). The CPU 106 then executes a control information updating process (step S1005). In the control information updating process, the CPU 106 updates the control information 200 and cancels the allocation of the cache data completed with the destage. Alternatively, the CPU 106 may turn off identification information, such as a flag, representing an example of dirty state and leave, on the memory 105, the data as cache data in a clean state (state in which the content of the data coincides with the content of the cache data on the drive). The details of the control information updating process will be described later.

Lastly, the CPU 106 invalidates the cache data log related to the destaged dirty data (step S1006). This completes the destaging process.

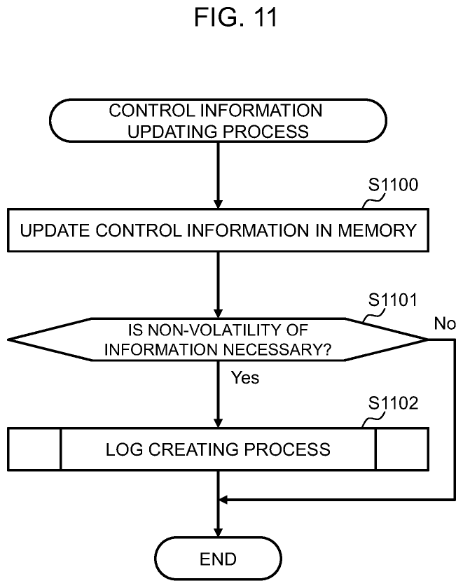

FIG. 11 is a flow chart illustrating an example of a procedure of the control information updating process. The CPU 106 first updates the control information in the memory 105 (step S1100). The CPU 106 then determines whether or not non-volatility of the information is necessary (step S1101). If the non-volatility of the information is necessary, the CPU 106 executes a log creating process (step S1102). On the other hand, if the non-volatility of the information is unnecessary, the CPU 106 skips the log creating process. The details of the log creating process will be described later. This completes the control information updating process.

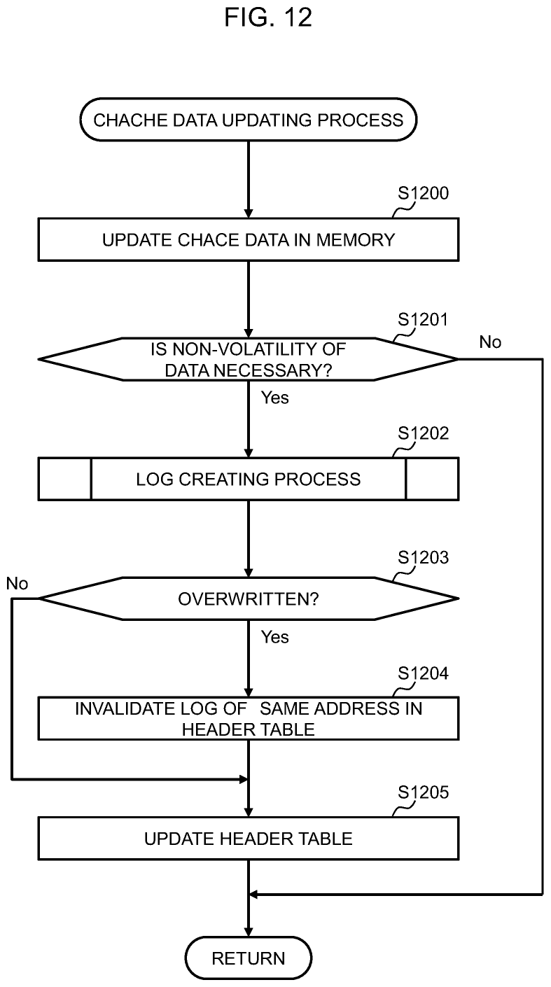

FIG. 12 is a flow chart illustrating an example of a procedure of the cache data updating process. The CPU 106 first updates the block-based data 201 in the memory 105 (step S1200). Specifically, the CPU 106 writes the block-based data 201 received from the host 102, to the cache area allocated in the memory 105, for example. The written block-based data 201 will also be referred to as cache data.

The CPU 106 then determines whether or not non-volatility of the data is necessary (S1201). If the non-volatility of the data is necessary, the CPU 106 executes step S1202. On the other hand, if the non-volatility of the data is unnecessary, the CPU 106 skips the following steps and ends the cache data updating process.

Step S1202 is the log creating process. This is a process of creating a cache data log related to the updated cache data, and the process will be described later.

The CPU 106 then determines whether or not the update of the cache data this time is overwriting (step S1203). Here, the CPU 106 checks whether or not the cache data log related to the update of the cache data in the address range included in the range of the cache area updated this time is present in the existing cache data logs. If the cache data log is present in the existing cache data logs, the CPU 106 determines that the update is overwriting.

Next, if the update is overwriting, the CPU 106 invalidates the log of the same address written in the log header table for managing the headers of logs, in order to overwrite the data (step S1204). On the other hand, if the update is not overwriting, the CPU 106 skips step S1204. Lastly, the CPU 106 updates the log header table. This completes the cache data updating process.

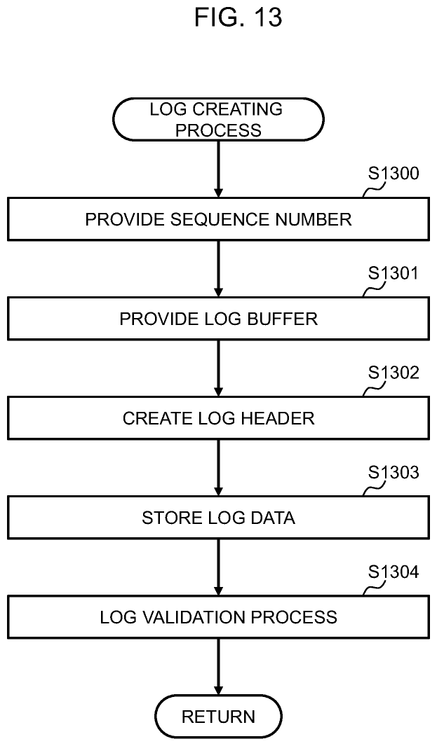

FIG. 13 is a flow chart illustrating an example of a procedure of the log creating process. The CPU 106 first provides a sequence number (step S1300). The sequence number is a number representing an example of an order of creation of the log. Every time a new log is created, the value is increased by one and attached to the new log.

The CPU 106 then provides a log buffer for temporarily storing a log to be created (step S1301). Specifically, the CPU 106 allocates an area with a size necessary to store the log to be created, from the control information log buffer 402 when the target to be stored in the log buffer is the control information 200 and from the cache data log buffer 403 when the target is the cache data.

The CPU 106 then creates a log header that is a header of the log (step S1302). The log header includes the sequence number, the address of the target data on the memory 105, the size of the target data, and the like. The CPU 106 then stores the log in the log buffer (step S1303).

Lastly, the CPU 106 executes a validation process of the created log (step S1304). Specifically, the log header includes a flag indicating validity/invalidity of the log, and the CPU 106 turns on the flag to validate the log, for example. This completes the log creating process.

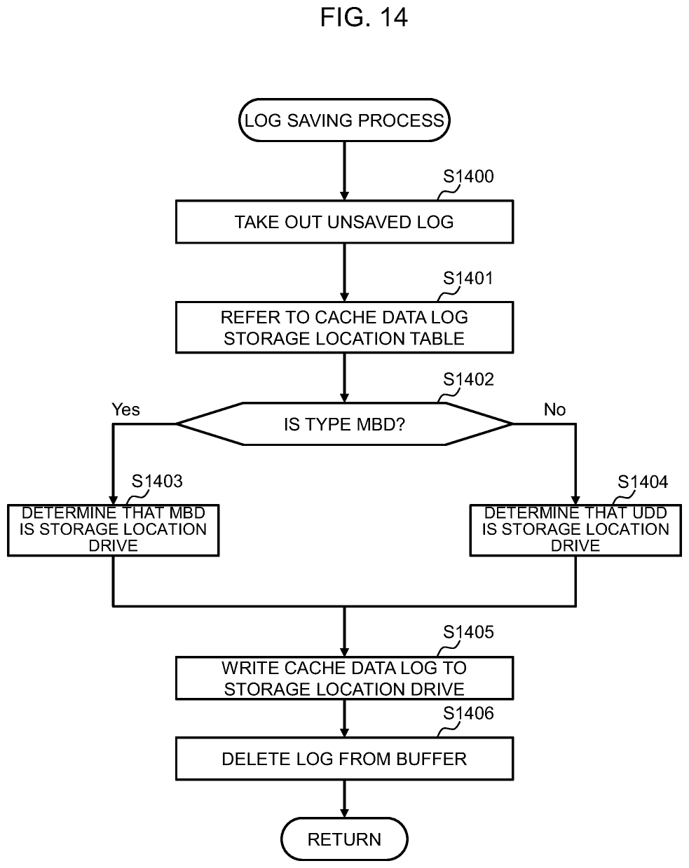

FIG. 14 is a flow chart illustrating an example of a procedure of the log saving process. The log saving process is a process of writing the log accumulated in the log buffer to the drive. The log saving process is called when the log needs to be written to the drive, as in step S806 of the writing process illustrated in FIG. 9 in which the process is called before the response is returned to the host.

The CPU 106 first takes out an unsaved log, that is, a log that has not been written to the drive yet, from the log buffer (step S1400). The CPU 106 refers to the cache data log storage location management table 699 (step S1401) and checks whether or not a type 601 of the ID for identifying the cache data is an “MBD” (see FIG. 6).

If the type 601 is the “MBD,” the CPU 106 determines that the memory backup drive 107 is the storage location drive. On the other hand, if the type 601 is not the “MBD,” the CPU 106 determines that the “UDD (drive 110)” is the storage location drive (corresponding to the illustrated “drive number”). The CPU 106 then writes the cache data log to the storage location drive designated by the type 601 and drive numbers 502 and 602 (step S1405).

Once the writing is completed, the CPU 106 deletes the written log from the log buffer (step S1406). This completes the log saving process.

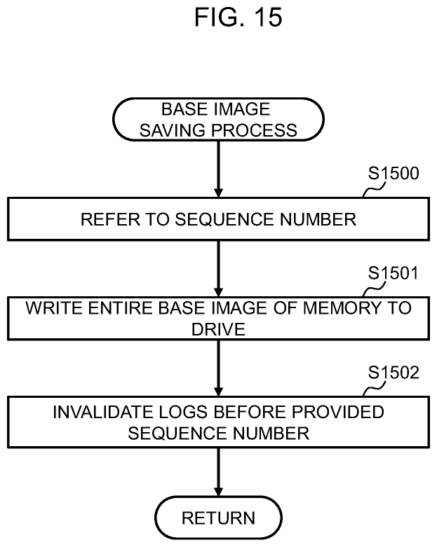

FIG. 15 is a flow chart illustrating an example of a procedure of a base image saving process. The base image saving process is a process of writing the storage content of the memory 105 to the drive. In the present embodiment, the base image saving process is used to protect the control information 200, and the process is executed at a predetermined timing, such as when more than a certain amount of control information logs are accumulated on the drive, for example.

The CPU 106 first refers to the sequence numbers and stores the newest sequence number at the moment (step S1500). The CPU 106 then writes the entire control information 200 as a base image to the drive (step S1501). Note that the writing to the drive may be divided into a plurality of times of writing. The old control information logs become unnecessary when the process is completed, and the CPU 106 invalidates all of the control information logs with numbers before the sequence number provided (stored) in step S1500 (step S1502). This completes the base image saving process.

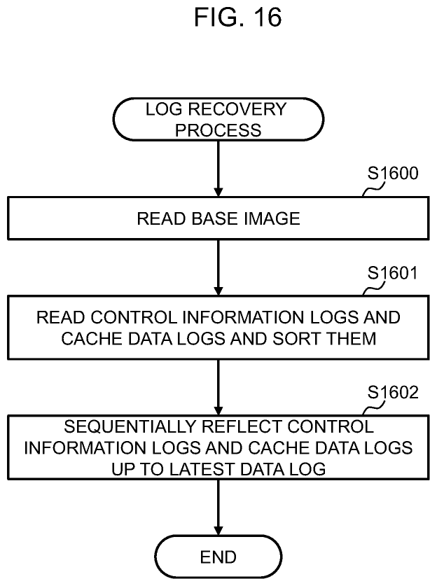

FIG. 16 is a flow chart illustrating an example of a procedure of a log recovery process. The log recovery process is executed in a process of starting the storage apparatus 100 after maintenance and replacement work of the controller 103 or the like after a system crash caused by blocking of both the controllers 103. This can recover the control information 200 and the dirty data stored in the memory 105 before the system crash. The CPU 106 of the controller 103 of the storage apparatus 100 executes the log recovery process before the restart of the reception of input and output.

The CPU 106 first reads the base image from the base image area on the drive 110 and stores the base image in the area of the control information 200 on the memory 105 (step S1600).

The CPU 106 reads the control information logs and the cache data logs (hereinafter, also abbreviated as “logs”) and sorts the logs from the oldest to the newest according to the sequence numbers (step S1601). The CPU 106 then reflects the content of the logs from the oldest to the newest in this order on the control information log buffer 402 and the cache data log buffer 403 on the memory 105, respectively, according to the addresses indicated by the log headers (step S1602). This completes the log recovery process.

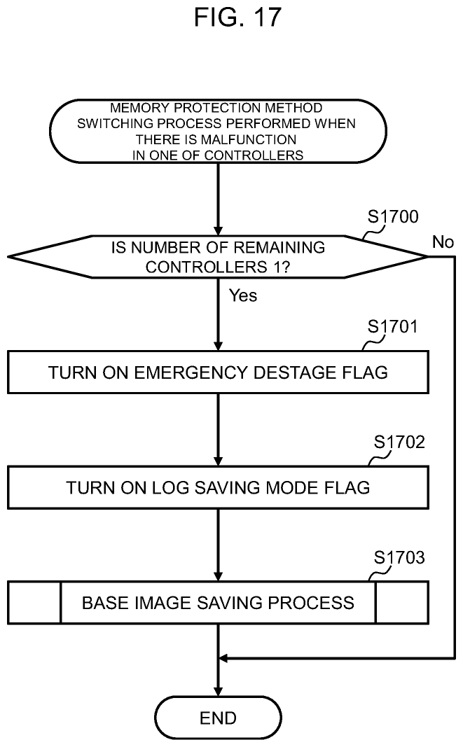

FIG. 17 is a flow chart illustrating an example of a procedure of a memory protection method switching process performed when one of the controllers 103 is blocked. The process is executed to switch the memory protection method from the duplication between the controllers 103 to the log-based protection when the other controller 103 detects that the one controller 103 is blocked due to a malfunction or the like.

The CPU 106 first determines whether or not the number of normal controllers 103 left in the storage apparatus 100 is one (that is, only the controller 103 including the CPU 106). If the number of remaining controllers 103 is one (Yes), the CPU 106 executes step S1701. If the number is not one (No), the CPU 106 skips all of the remaining steps and ends the process.

The CPU 106 then turns on an emergency destage flag indicating whether or not emergency destaging is being executed (step S1701). While the emergency destage flag is turned on, the CPU 106 increases the execution frequency of the destaging process to store the dirty data in the drive 110 as quickly as possible.

The CPU 106 then turns on a log saving mode flag indicating whether or not the mode for saving the log is set (step S1702). Lastly, the CPU 106 executes the base image saving process.

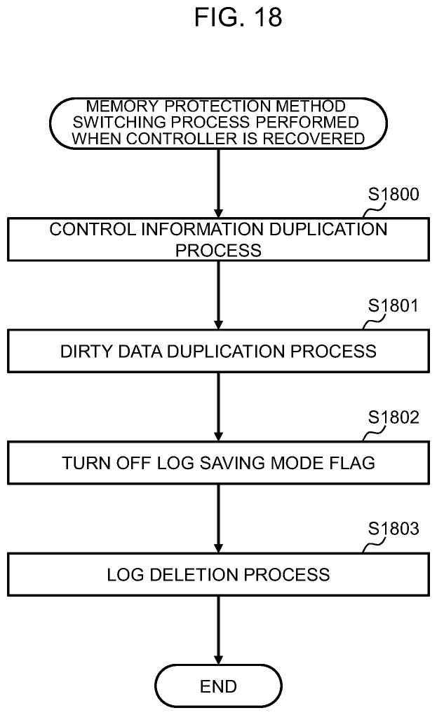

FIG. 18 is a flow chart illustrating an example of a procedure of a memory protection method switching process performed when the controller 103 is recovered. The process is executed to switch back the memory protection method from the log-based protection to the duplication between the controllers 103 when the normal operation state of the other controller 103 is detected after the other controller 103 is recovered by maintenance, replacement, or the like.

The CPU 106 first executes a control information duplication process (step S1800). The control information duplication process is a process of copying the control information 200 on the memory 105 to the memory 105 of the recovered controller 103. The control information duplication process ends when the copying of all the control information 200 is finished.

The CPU 106 then executes a duplication process of the dirty data (step S1801). The duplication process is a process of copying the dirty data on the memory 105 to the memory 105 of the recovered other controller 103. Further, every time the dirty data is copied, the cache control information related to the dirty data is updated. The process is completed when the copying of all the dirty data is finished. Note that a method for protecting the dirty data by destaging the dirty data to the drive 110 may be adopted, instead of copying the dirty data to the other controller 103 as in the present embodiment.

The CPU 106 then turns off the log saving mode flag (step S1802).

Lastly, the CPU 106 executes a log deletion process (step S1803). The log deletion process is a process of deleting all of the written logs and the logs on the log buffers (the control information log buffer 402 and the cache data log buffer 403). For example, all of the logs stored in the drive 110 and the memory 105 may be overwritten with invalid values such as all zeros, or instead of this, the valid flags of all of the log headers may be turned off to invalidate all of the logs.

As described above, the storage apparatus 100 according to the present embodiment includes the plurality of kinds of drives 107 and 110 that store the data in a non-volatile manner, the plurality of controllers 103 that control the reading and writing of the data to and from the plurality of kinds of drives 107 and 110 according to the input and output of the data to and from the host 102, and the volatile memory 105 (cache memory) that temporarily stores the data. Each of the controllers 103 includes the data protection step of executing the memory data protection function of generating the log including the data of the memory 105 and the header related to the update of the data and writing the log to any one of the plurality of kinds of drives 107 and 110, and in the data protection step, the controller 103 uses the memory data protection function to select, from the plurality of kinds of drives 107 and 110, the drive that is to store the log, according to the necessary performance.

In this way, the drive that is to store the log is selected according to the necessary performance, and the drive can have enough performance with minimum required specifications. This can secure high reliability while balancing the cost and the performance.

In the present embodiment, when one of the plurality of controllers 103 is blocked, the other controller 103 not blocked executes the memory data protection function. In this way, the other controller 103 not blocked can more surely store the log to the drive with minimum required specifications.

The storage apparatus 100 according to the present embodiment includes the memory backup drive 107 as a storage area for saving the storage content of the memory 105 of the one controller 103 when the one controller 103 is blocked, and the drive 110 for user data that reads and writes the data regardless of whether or not the one controller 103 is blocked. In this way, the memory backup drive 107 as a storage area for saving the storage content of the memory 105 of the controller 103 and the drive 110 for user data that reads and writes the data regardless of whether or not the one controller 103 is blocked are used as the plurality of kinds of non-volatile drives. Therefore, a dedicated drive does not have to be newly provided, and the cost can be suppressed.

In the present embodiment, the other controller 103 selects the drive that is to store the log from the plurality of kinds of drives 107 and 110 in the data protection step when, for example, the necessary performance is set to prioritize that the predetermined performance requirement related to the reading and writing speed of the data is satisfied (corresponding to the “performance prioritized”). In this way, the drive with enough performance can be selected according to the setting.

In the present embodiment, the drive 110 for user data includes at least one SSD, and the other controller 103 selects the SSD as the drive that is to store the log in the data protection step. In this way, the log can quickly be stored.

In the present embodiment, the data includes the plurality of pieces of block-based data in which the data is divided into blocks. The cache data log includes the block-based data and the header related to the update of the block-based data, and the other controller 103 selects, from the plurality of kinds of drives 107 and 110, the drive that is to store the block-based data and the header as the cache data log in the data protection step. In this way, although the amount of data is large because the cache data log includes the block-based data, the cache data log is stored in a suitable drive among the plurality of kinds of non-volatile drives according to whether or not the satisfaction of the predetermined performance requirement is prioritized in the setting.

The storage apparatus 100 according to the present embodiment includes the cache data log storage location management table 699 as an example of the storage location management table for managing the information related to at least the type and the capacity size regarding the plurality of kinds of drives, and the other controller 103 refers to the cache data log storage location management table 699 to select the drive that is to store the cache data log in the data protection step. In this way, when the drive that is to store the cache data log is set in advance in the cache data log storage location management table 699, the other controller 103 can refer to the cache data log storage location management table 699 to store the cache data log in the suitable drive.

Note that the present invention is not limited to the embodiment, and the present invention includes various modifications and equivalent configurations within the scope of the attached claims. For example, the embodiment is described in detail to facilitate the understanding of the present invention, and the present invention may not be limited to the embodiment including all of the described configurations. At least one of the elements described in parallel in the present embodiment may be connected in series to another element.

The present invention can be applied to a storage apparatus related to a technique for writing data of a memory and update content of the data as a data log to a drive in a process of inputting and outputting data to and from a host.

What is claimed is:

1. A storage apparatus comprising:
a plurality of kinds of drives that store data in a non-volatile manner;
a plurality of controllers that control reading and writing of the data to and from a host; and
a volatile memory that temporarily stores the data, wherein
each of the plurality of controllers has a memory data protection function of generating a cache data log including the data of the memory and a header related to update content of the data and writing the cache data log to any one of the plurality of kinds of drives, and
the controller uses the memory data protection function to select, from the plurality of kinds of drives, a drive that is to store the cache data log, according to necessary performance, and store the cache data log in the selected drive.

2. The storage apparatus according to claim 1, wherein,
when one of the plurality of controllers is blocked, another controller not blocked executes the memory data protection function.

3. The storage apparatus according to claim 2, wherein
the plurality of kinds of drives includes
a memory backup drive as a storage area for saving storage content of the memory of the one controller when the one controller is blocked, and
a drive for user data that reads and writes the data regardless of whether or not the one controller is blocked.

4. The storage apparatus according to claim 3, wherein
the other controller
selects the memory backup drive from the plurality of kinds of drives when the necessary performance is set to prioritize that a predetermined performance requirement related to reading and writing speed of data is satisfied, and
selects the drive for user data from the plurality of kinds of drives when the necessary performance is set to not prioritize that the predetermined performance requirement is satisfied.

5. The storage apparatus according to claim 2, wherein
the plurality of kinds of drives include at least one solid state drive, and
the other controller selects the solid state drive from the plurality of kinds of drives when the necessary performance is set to prioritize that the predetermined performance requirement is satisfied.

6. The storage apparatus according to claim 2, wherein
the data includes a plurality of pieces of block-based data in which the data is divided into blocks,
the cache data log includes
the block-based data, and
a header related to update content of the block-based data, and
the other controller selects, from the plurality of kinds of drives, a drive that is to store the block-based data and the header as the cache data log.

7. The storage apparatus according to claim 2, further comprising:
a storage location management table for managing information related to at least a type and a capacity size regarding the plurality of kinds of drives, wherein
the other controller refers to the storage location management table to select the drive that is to store the cache data log.

8. A storage location control method of a storage apparatus including a plurality of kinds of drives that store data in a non-volatile manner, a plurality of controllers that control reading and writing of the data to and from a host, and a volatile memory that temporarily stores the data, the storage location control method comprising:
a data protection step of executing, by each of the plurality of controllers, a memory data protection function of generating a cache data log including the data of the memory and a header related to update content of the data and writing the cache data log to any one of the plurality of kinds of drives, wherein,
in the data protection step, the controller uses the memory data protection function to select, from the plurality of kinds of drives, a drive that is to store the cache data log, according to necessary performance, and store the cache data log in the selected drive.

9. The storage location control method according to claim 8, wherein,
when one of the plurality of controllers is blocked, another controller not blocked executes the memory data protection function in the data protection step.

10. The storage location control method according to claim 9, wherein
the plurality of kinds of drives includes
a memory backup drive as a storage area for saving storage content of the memory of the one controller when the one controller is blocked, and
a drive for user data that reads and writes the data regardless of whether or not the one controller is blocked.

11. The storage location control method according to claim 10, wherein
the other controller in the data protection step
selects the memory backup drive from the plurality of kinds of drives when the necessary performance is set to prioritize that a predetermined performance requirement related to reading and writing speed of data is satisfied, and
selects the drive for user data from the plurality of kinds of drives when the necessary performance is set to not prioritize that the predetermined performance requirement is satisfied.

12. The storage location control method according to claim 9, wherein
the plurality of kinds of drives include at least one solid state drive, and
the other controller in the data protection step selects the solid state drive from the plurality of kinds of drives when the necessary performance is set to prioritize that the predetermined performance requirement is satisfied.

13. The storage location control method according to claim 9, wherein
the data includes a plurality of pieces of block-based data in which the data is divided into blocks,
the cache data log includes
the block-based data, and
a header related to update content of the block-based data, and
the other controller in the data protection step selects, from the plurality of kinds of drives, a drive that is to store the block-based data and the header as the cache data log.

14. The storage location control method according to claim 9, further comprising:
a storage location management table for managing information related to at least a type and a capacity size regarding the plurality of kinds of drives, wherein
the other controller in the data protection step refers to the storage location management table to select the drive that is to store the cache data log.
